(19) United States
(12) Patent Application Publication
(10) Pub. No.: US 2003/0222854 A1
(43) Pub. Date: Dec. 4, 2003

(54) Information processing apparatus and system locking method

(75) Inventors: Takao Yurugi, Ome-shi (JP); Akinori Tokunaga, Kokubunji-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/443,025

(22) Filed: May 22, 2003

(30) Foreign Application Priority Data
May 31, 2002 (JP) 2002-159991

(51) Int. Cl. G09G 5/00

(52) U.S. Cl. 345/172

(57) ABSTRACT

An information processing apparatus includes a button to be depressed, and a control section which emulates a key depressing operation corresponding to a system locking operation when the button is depressed. This causes a system to be easily locked by a single button operation.

### CROSS-REFERENCE TO RELATED APPLICATIONS

This application is based upon and claims the benefit of priority from the prior Japanese Patent Application No. 2002-159991, filed May 31, 2002, the entire contents of which are incorporated herein by reference.

### BACKGROUND OF THE INVENTION

1. Field of the Invention

The present invention relates to an information processing apparatus and a system locking method capable of causing a system to be locked.

2. Description of the Related Art

An information processing apparatus such as a personal computer is provided with a function of setting a system to be locked in response to a user's instruction.

For example, if a user must leave an information processing apparatus unattended, he or she can use a predetermined shortcut key to lock the system. In this case, the shortcut key may be a command on a menu specified by operating, for example, “Ctrl”+“Alt”+“Del” keys on a keyboard.

The information processing apparatus such as a personal computer is also provided with a function called a “screen saver”. The screen saver is a function of automatically switching an image displayed on a screen to another preset image after nothing has been input for a specified period. The above locked status can also be accomplished using such a screen saver. Further, it is possible to set a power supply to an LCD to be turned off by using the screen saver function after nothing has been input for a specified period.

However, the shortcut key used to lock the system includes a plurality of predetermined keys. Thus, the user must be sure to remember the combination of the plurality of predetermined keys in order to successfully lock the system. The system is provided with various shortcut keys corresponding to respective purposes. Accordingly, the user cannot remember the required shortcut key easily and forgets it readily.

Further, if the screen saver is used to lock the system, the user must wait (for example, for several minutes) before the screen saver is activated. Consequently, the user cannot immediately leave the information processing apparatus.

Accordingly, it is desirable to implement a mechanism that immediately locks the system in response to a simple operation without the need to use any shortcut keys including a combination of a plurality of keys.

### BRIEF SUMMARY OF THE INVENTION

Embodiments of the present invention may provide an information processing apparatus and a system locking method which cause a system to be easily locked by a single button operation.

According to an aspect of the present invention, there is provided an information processing apparatus comprising a button to be depressed; and a control section which emulates a key depressing operation corresponding to a system locking operation when the button is depressed.

According to another aspect of the present invention, there is provided a system locking method applied to an information processing apparatus, comprising detecting an operation of depressing a specific button; and emulating a key depressing operation corresponding to a system locking operation when the button is depressed.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the appearance of a computer according to an embodiment of the present invention with its display opened;

FIG. 2 is a block diagram showing a system configuration of the computer according to the embodiment;

FIG. 3 is a diagram showing an example of arrangement of buttons on a remote control unit that can communicate with the computer according to the embodiment;

FIG. 4 is a block diagram showing a first example of a locking process mechanism according to the embodiment;

FIG. 5 is a flow chart showing a locking process procedure in the first example of the locking process mechanism according to the embodiment;

FIG. 6 is a flow chart showing an unlocking process procedure in the first example of the locking process mechanism according to the embodiment;

FIG. 7 is a block diagram showing a second example of the locking process mechanism according to the embodiment;

FIG. 8 is a flow chart showing a locking process procedure in the second example of the locking process mechanism according to the embodiment;

FIG. 9 is a block diagram showing a third example of the locking process mechanism according to the embodiment;

FIG. 10 is a flow chart showing a locking process procedure in the third example of the locking process mechanism according to the embodiment;

FIG. 11 is a block diagram showing a variation of FIG. 4;

FIG. 12 is a block diagram showing a variation of FIG. 7; and

FIG. 13 is a block diagram showing a variation of FIG. 9.

### DETAILED DESCRIPTION OF THE INVENTION

Embodiments of the present invention will be described below with reference to the drawings.

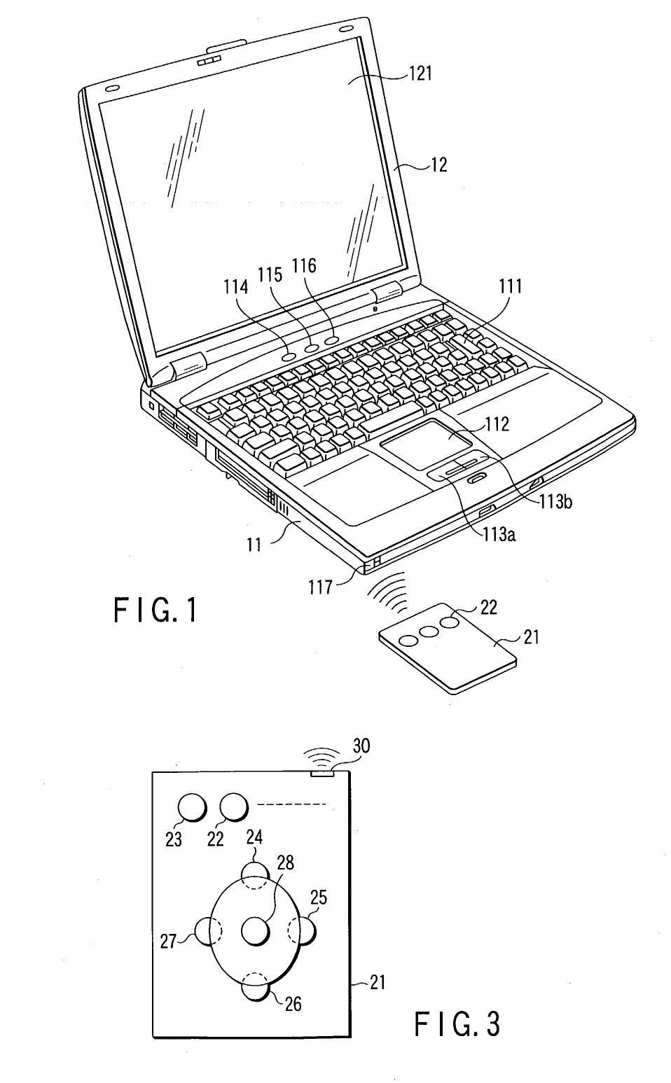

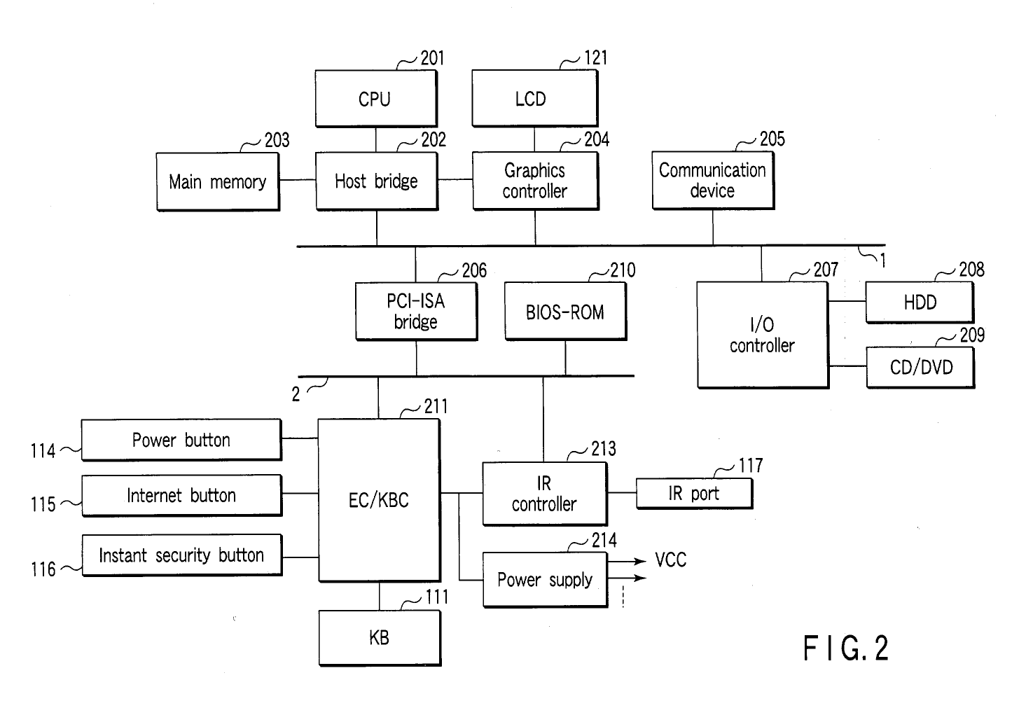

First, with reference to FIGS. 1 and 2, description will be given of a configuration of an information processing apparatus according to an embodiment of the present invention. In this case, it is assumed that the present invention is implemented as a notebook type personal computer.

FIG. 1 is a front view showing that a display unit of the personal computer is opened. The personal computer includes a computer main body 11 and a display unit 12. The display unit 12 has an LCD (Liquid Crystal Display) 121 incorporated therein. A display screen of the LCD 121 is located substantially in the center of the display unit 12.

The display unit 12 is attached to the computer main body 11 so as to rotationally move freely between a released position and a closed position. The computer main body 11 is a thin box-shaped housing. A keyboard 111, a touch pad 112, and left and right touch pad buttons 113a and 113b, respectively, are arranged on a top surface of the computer main body 11.

Furthermore, a power button 114 used to power on/off the personal computer and two accessory buttons 115 and 116 used to execute predetermined functions are provided on the top surface of the computer main body 11 behind the keyboard 111. The accessory buttons 115 and 116 are external input buttons as hardware. Each is used as an exclusive operation button that activates a predetermined function in response to a user's operation.

An arbitrary application program can be assigned to the accessory button 115. An Internet browser is often assigned to the accessory button 115 by default. In this case, the accessory button 115 is called an “Internet button”.

A function for locking the system is assigned to the accessory button 116. The accessory button 116 is depressed once to automatically set a predetermined type of locked status. The user can change system settings or set the system beforehand so that a password must be input before the locked status can be cleared. Thus, in the present embodiment, the system can be locked, while maintaining security. In this case, the accessory button 116 is called an “instant security button”.

Furthermore, a communication port 117 is provided on a front surface of the computer main body 11 to communicate with an external remote control unit 21. The communication port 117 is a transmission and reception section used to transmit and receive data to and from external apparatuses using, for example, infrared rays. The communication port 117 will be hereinafter referred to as an “IR port”.

The remote control unit 21 is an external device that allows operations of the personal computer to be remotely controlled. A plurality of control buttons are arranged on the remote control unit 21. One of them is an instant security button 22. Like the instant security button 116 on the computer main body, the instant security button 22 is used to lock the system.

The remote control unit 21 enables a predetermined type of locked status to be automatically established by depressing the instant security button 22 once even if the user is away from the personal computer.

FIG. 2 shows a system configuration of the personal computer. As shown in this figure, the personal computer is provided with a CPU 201, a host bridge 202, a main memory 203, a graphics controller 204, a communication device 205, a PCI-ISA bridge 206, an I/O controller 207, a hard disk drive (HDD) 208, a CD/DVD drive 209, a BIOS-ROM 210, an embedded controller/keyboard controller (EC/KBC) 211, an infrared communication controller (IR controller) 213, a power controller 214, and the like.

The CPU 201 is a processor provided to control overall operations of the personal computer. It executes an operation system (OS) and an application program/utility program which are loaded into the main memory 203 from the hard disk drive (HDD) 208. The CPU 201 also executes a BIOS (Basic Input/Output System) stored in the BIOS-ROM 210. A system locking function using the instant security button 22 or 116 is accomplished using an exclusive utility program.

The host bridge 202 is a bridge device that connects a local bus in the CPU 201 and a PCI bus 1. The graphics controller 204 controls the LCD 121, used as a display monitor of the personal computer. The communication device 205 is a PCI device used to connect to a computer network such as the Internet. The I/O controller 207 is also a PCI device containing an IDE controller and the like to control the hard disk (HDD) 208 and the CD/DVD drive 209.

The PCI-ISA bridge 206 is a bridge device that connects the PCI bus and an ISA bus 2. The PCI-ISA bridge 206 also contains various system devices such as a system timer, a DMA controller, and an interruption controller. The BIOS is stored in the BIOS-ROM 210. The BIOS is a program for controlling hardware components in the present system. The BIOS includes a button event processing routine to process a button event generated in response to the user's operation of depressing the instant security button 22 or 116.

The embedded controller/keyboard controller (EC/KBC) 211 is a one-chip microcomputer into which an embedded controller used to manage power and a keyboard controller used to control the keyboard 111 are integrated. The EC/KBC 211 has a function of cooperating with the power controller 214 in powering on/off the personal computer in response to the user's operation of the power button 114. Further, when the user depresses the instant security button 22 or 116, the EC/KBC 211 generates a button event indicating that the button has been depressed. For example, a hardware interruption signal is used to notify the CPU 201 that the button event has been generated. Then, the CPU 201 calls the button event processing routine in the BIOS.

The IR controller 213 is a communication device that transmits and receives data to and from external apparatuses, using infrared rays. When the IR controller 213 receives a signal via the IR port 117 which is transmitted by the remote controller 21, the EC/KBC 211 generates a button event.

FIG. 3 shows an example of arrangement of the buttons on the remote unit 21. The remote control unit 21 has, for example, a thin card-like housing. In addition to the above described instant security button 22, a power button 23, cursor buttons 24, 25, 26, and 27, an enter button 28, and the like are provided on a top surface of the remote control unit 21, as shown in the figure. Furthermore, an IR port 30 for infrared communications is provided at an end of the card-like housing.

The power button 23 is used to give an instruction to power on/off the personal computer. The cursor buttons 24, 25, 26, and 27 correspond to a “↑” key, a “→” key, a “↓” key, and a “←” key on the keyboard 111. Further, the enter button 28 corresponds to the “Enter” key on the keyboard 111. Whatever button is depressed, the remote unit 21 transmits a signal corresponding to the depressed button to the computer using an infrared ray.

(First Example of Locking Process Mechanism)

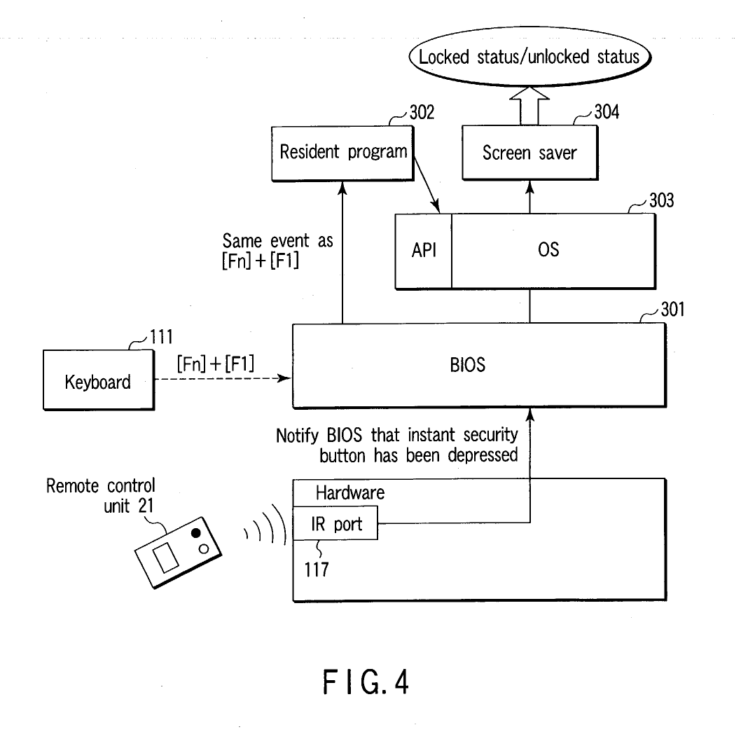

Now, with reference to FIGS. 2 and 4, description will be given of a first example of a locking process mechanism according to the present embodiment. In this case, description will be given of an approach to locking the system by emulating an operation of depressing “Fn”+“F1”, a combination of keys used to activate a system locking screen saver.

When the user depresses, for example, the instant security button 22 on the remote control unit 21, the remote control unit 21 transmits a signal to the computer which indicates that the instant security button 22 has been depressed, using infrared rays. This signal contains code data corresponding to the instant security button 22. The IR controller 213 receives the signal transmitted by the remote control unit 21, via the IR port 117.

In response to the reception of the signal by the IR controller 213, the EC/KBC 211 generates a button event indicating that the instant security button 22 has been depressed. An interruption signal to the CPU 201 or the like is used to notify the BIOS 301 that the button event has been generated. The button event processing routine in the BIOS 301 is thus executed.

The button event processing routine in the BIOS 301 examines the cause of generation of the button event in the EC/KBC 211. This is carried out by, for example, checking a value in a status register in the EC/KBC 211. Code data indicating the depressed button is stored in the status register.

If the button event has been generated because of depression of the instant security button 22, the button event processing routine in the BIOS 301 issues an event corresponding to an operation of depressing “Fn”+“F1”, a combination of keys used to activate a screen saver. This event is transmitted to a resident program 302 (described later).

The resident program (utility program) 302 is always present in the main memory 203 while the OS 303 is operating. Upon receiving from the BIOS 301 the event corresponding to the operation of depressing the “Fn”+“F1”, the resident program 302 requests an API (Application Program Interface) managed by the OS 303 to activate a system locking screen saver 304. The resident program is implemented as an execution program (module) that executes, for example, a hot key event.

In response to the request from the resident program 302, the API managed by the OS 303 activates the system locking screen saver 304 to lock the system. Further, a registry for the OS 303 or the like manages various kinds of information, such as the type and status of the screen saver 304 executed in this case. The API also requests the BIOS 301 to power off the LCD 121. Processing is thus executed to power off the LCD under the control of the BIOS 301.

It is possible to set the OS 303 so that a predetermined password must be input before the system locked status can be cleared. If a password has been set, the OS 303 displays on the LCD 121 a password input dialog urging the user to input the password when the user operates the keyboard or mouse (an unlocking request operation). If the correct password is input, the OS 303 clears the system locked status (the OS 303 ends the operation of the screen saver 304).

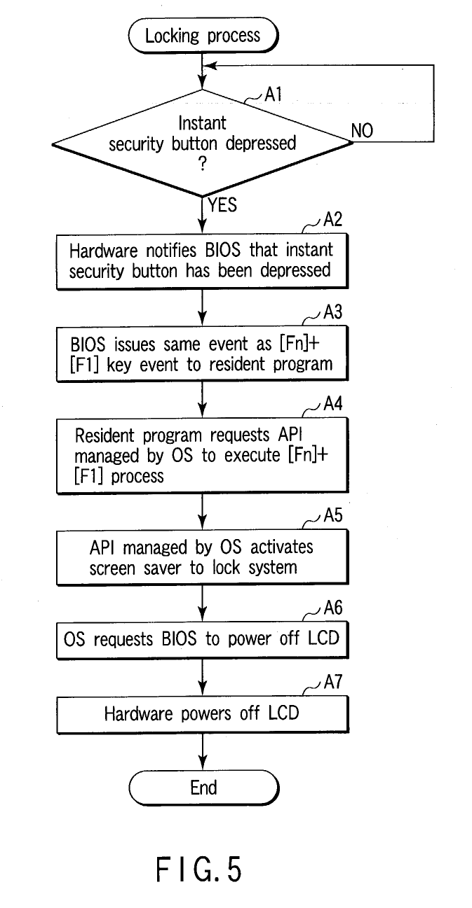

Now, with reference to the flow chart in FIG. 5, description will be given of a locking process procedure in the first example of the locking process mechanism.

Upon detecting that the instant security button 22 on the remote control unit 21 has been depressed (step A1), the hardware notifies the BIOS 301 that the instant security button 22 has been depressed (step A2).

Upon receiving the notification that the instant security button 22 has been depressed, the BIOS 301 issues, to the resident program 302, an event corresponding to an operation of depressing the “Fn”+“F1”, a combination of keys used to activate the system locking screen saver 304 (step A3).

Upon receiving from the BIOS 301 the event corresponding to the operation of depressing the “Fn”+“F1”, the resident program (utility program) 302 requests the API managed by the OS 303 to execute processing for the “Fn”+“F1” (that is, activates the system locking screen saver 304) (step A4).

In response to the request from the resident program 302, the API managed by the OS 303 activates the screen saver 304 to lock the system (step A5).

Further, the API requests the BIOS 301 to power off the LCD 121 (step A6). Thus, the hardware powers off the LCD under the control of the BIOS 301 (step A7).

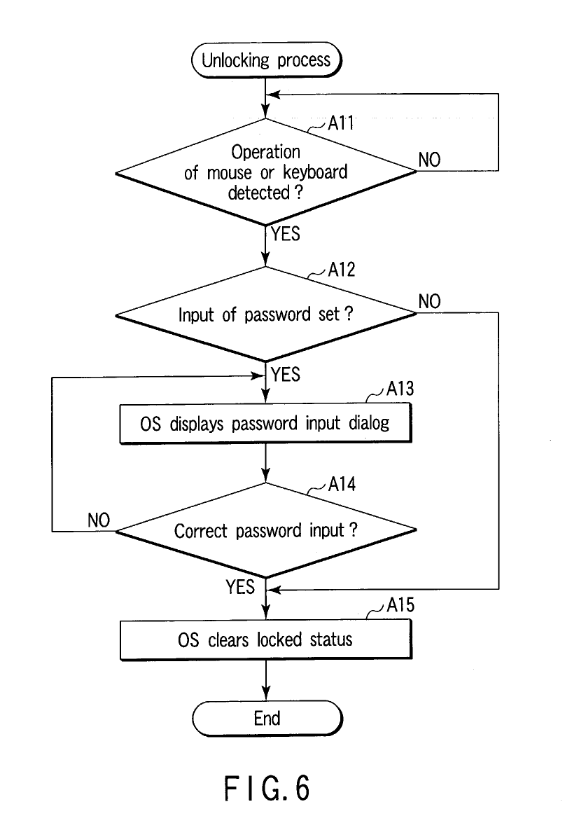

Now, with reference to the flow chart in FIG. 6, description will be given of an unlocking process procedure in the first example of the locking process mechanism.

If the user operates the keyboard or the mouse (an unlocking request operation) (step A11), the OS 303 determines whether or not a password has been set which is used to clear the system locked status.

If no passwords have been set, the OS 303 immediately clears the system locked status (ends the operation of the screen saver 304) (step A15). Further, at this time, the OS 303 performs a process of powering-on the LCD, and other processes. On the other hand, if a password has been set, the OS 303 displays on the LCD 121 the password input dialog urging the user to input the password (step A13).

If an incorrect password has been input, the OS 303 urges the user to reenter the password. On the other hand, if a correct password has been input, the OS 303 immediately clears the system locked status (ends the operation of the screen saver 304) (step A15). Further, at this time, the OS 303 performs a process of powering-on the LCD, and other processes.

(Second Example of Lock Processing Mechanism)

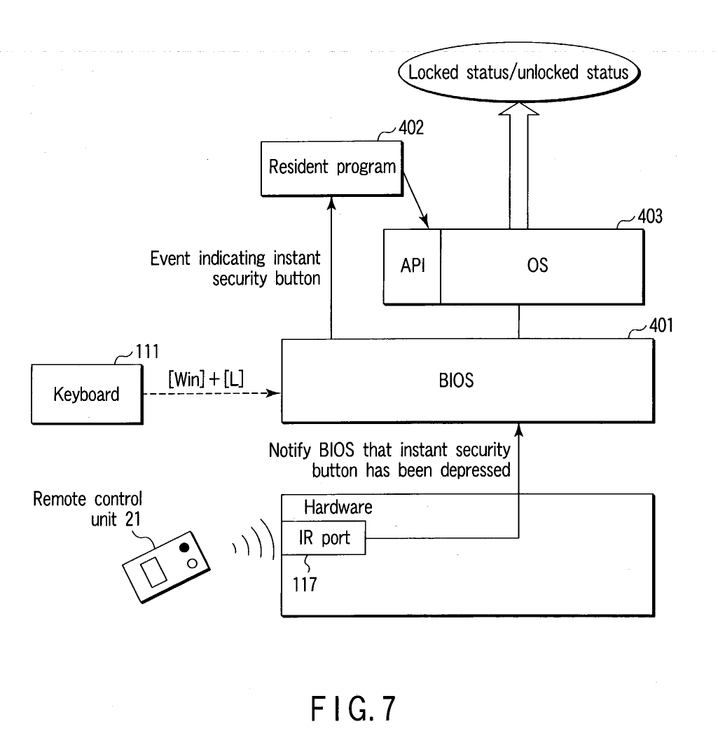

Now, with reference to FIGS. 2 and 7, description will be given of a second example of a locking process mechanism according to the present embodiment. In this case, description will be given of an approach to locking the system by emulating an operation of depressing “Win”+“L”. In this case, the “Win” key is a kind of function key combined with other keys to execute various commands.

When the user depresses the instant security button 22 on the remote control unit 21, the remote control unit 21 transmits a signal to the computer which indicates that the instant security button has been depressed, using infrared rays. This signal contains code data corresponding to the instant security button 22. The IR controller 213 receives the signal transmitted by the remote control unit 21, via the IR port 117.

In response to the reception of the signal by the IR controller 213, the EC/KBC 211 generates a button event indicating that the instant security button 22 has been depressed. An interruption signal to the CPU 201 or the like is used to notify a BIOS 401 that the button event has been generated. A button event processing routine in the BIOS 401 is thus executed.

The button event processing routine in the BIOS 401 examines the cause of generation of the button event in the EC/KBC 211. This is carried out by, for example, checking a value in the status register in the EC/KBC 211. Code data indicating the depressed button is stored in the status register.

If the button event has been generated because of depression of the instant security button 22, the button event processing routine in the BIOS 401 issues an event indicating the depression of the instant security button 22. This event is transmitted to a resident program 402 (described later).

The resident program (utility program) 402 is always present in the main memory 203 while an OS 403 is operating. Upon receiving from the BIOS 401 the event corresponding to the depression of the instant security button 22, the resident program 402 requests the API managed by the OS 403 to lock the system.

In response to the request from the resident program 402, the API managed by the OS 403 locks the system. Further, in this case, a registry for the OS 403 or the like manages various kinds of information, such as the type and status of a locking process.

It is possible to set the OS 403 so that a predetermined password must be input before the system locked status can be cleared. If a password has been set, the OS 403 displays on the LCD 121 a password input dialog urging the user to input the password when the user operates the keyboard or mouse (an unlocking request operation). If a correct password is input, the OS 403 clears the system locked status.

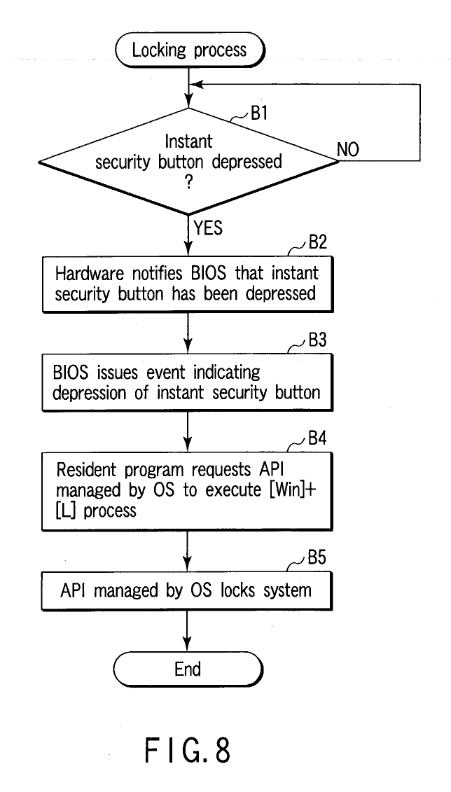

Now, with reference to the flow chart in FIG. 8, description will be given of a locking process procedure in the second example of the locking process mechanism.

Upon detecting that the instant security button 22 on the remote control unit 21 has been depressed (step B1), the hardware notifies the BIOS 401 that the instant security button 22 has been depressed (step B2).

Upon receiving the notification that the instant security button 22 has been depressed, the BIOS 401 issues, to the resident program 402, an event corresponding to the depression of the instant security button 22 (step B3).

Upon receiving from the BIOS 401 the event indicating to the depression of the instant security button 22, the resident program (utility program) 402 requests the API managed by the OS 403 to execute processing for the “Win”+“L” (that is, lock the system) (step B4).

In response to the request from the resident program 402, the API managed by the OS 403 locks the system (step B5).

An unlocking process procedure in this example is similar to that in the previously described first example (FIG. 6). Its description is thus omitted.

(Third Example of Lock Processing Mechanism)

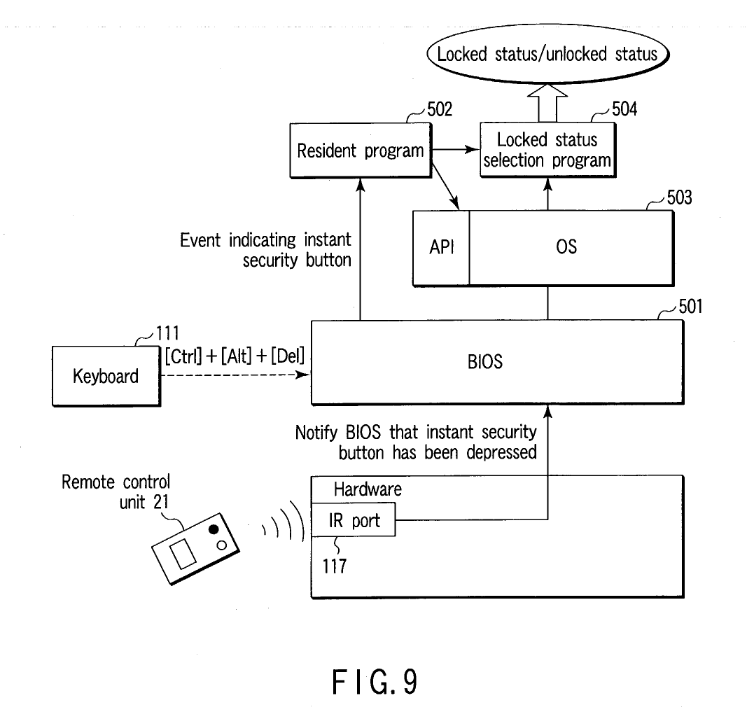

Now, with reference to FIGS. 2 and 9, description will be given of a third example of a locking process mechanism according to the present embodiment. In this case, description will be given of an approach to locking the system by emulating an operation of depressing “Ctrl”+“Alt”+“Del”.

When the user depresses the instant security button 22 on the remote control unit 21, the remote control unit 21 transmits a signal to the computer which indicates that the instant security button has been depressed, using infrared rays. This signal contains code data corresponding to the instant security button 22. The IR controller 213 receives the signal transmitted by the remote control unit 21, via the IR port 117.

In response to the reception of the signal by the IR controller 213, the EC/KBC 211 generates a button event indicating that the instant security button 22 has been depressed. An interruption signal to the CPU 201 or the like is used to notify a BIOS 501 that the button event has been generated. A button event processing routine in the BIOS 501 is thus executed.

The button event processing routine in the BIOS 501 examines the cause of generation of the button event in the EC/KBC 211. This is carried out by, for example, checking a value in the status register in the EC/KBC 211. Code data indicating the depressed button is stored in the status register.

If the button event has been generated because of depression of the instant security button 22, the button event processing routine in the BIOS 501 issues an event indicating the depression of the instant security button 22. This event is transmitted to a resident program 502 (described later).

The resident program (utility program) 502 is always present in the main memory 203 while an OS 503 is operating. Upon receiving from the BIOS 501 the event corresponding to the depression of the instant security button 22, the resident program 502 requests the API managed by the OS 503 to lock the system.

In response to the request from the resident program 502, the API managed by the OS 503 activates a locked status selection program 504. The activated locked status selection program 504 presents various selectable types of locked status. Then, the resident program 502 selects one of these types. The API realizes the locked status selected by the resident program 502. Further, in this case, a registry for the OS 503 or the like manages various kinds of information, such as the type and status of a locking process.

It is possible to set the OS 503 so that a predetermined password must be input before the system locked status can be cleared. If a password has been set, the OS 503 displays on the LCD 121 a password input dialog urging the user to input the password when the user operates the keyboard or mouse (an unlocking request operation). If a correct password is input, the OS 503 clears the system locked status.

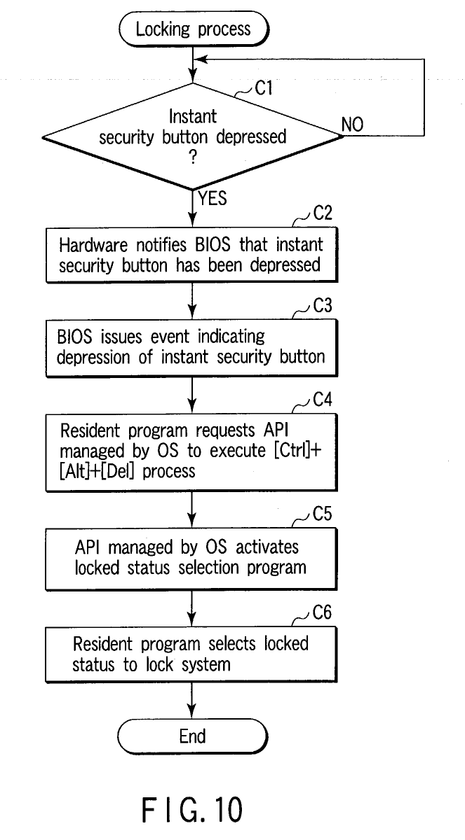

Now, with reference to the flow chart in FIG. 10, description will be given of a locking process procedure in the third example of the locking process mechanism.

Upon detecting that the instant security button 22 on the remote control unit 21 has been depressed (step C1), the hardware notifies the BIOS 501 that the instant security button 22 has been depressed (step C2).

Upon receiving the notification that the instant security button 22 has been depressed, the BIOS 501 issues, to the resident program 502, an event corresponding to the depression of the instant security button 22 (step C3).

Upon receiving from the BIOS 501 the event indicating to the depression of the instant security button 22, the resident program (utility program) 502 requests the API managed by the OS 503 to execute processing for the “Ctrl”+“Alt”+“Del” (that is, lock the system) (step C4).

In response to the request from the resident program 502, the API managed by the OS 503 activates the locked status selection program 504 (step C5).

The resident program 502 selects one of the various types of locked status presented by the activated locked status selection program 504. Thus, the API brings the system into the desired locked status (step C6).

An unlocking process procedure in this example is similar to that in the previously described first example (FIG. 6). Its description is thus omitted.

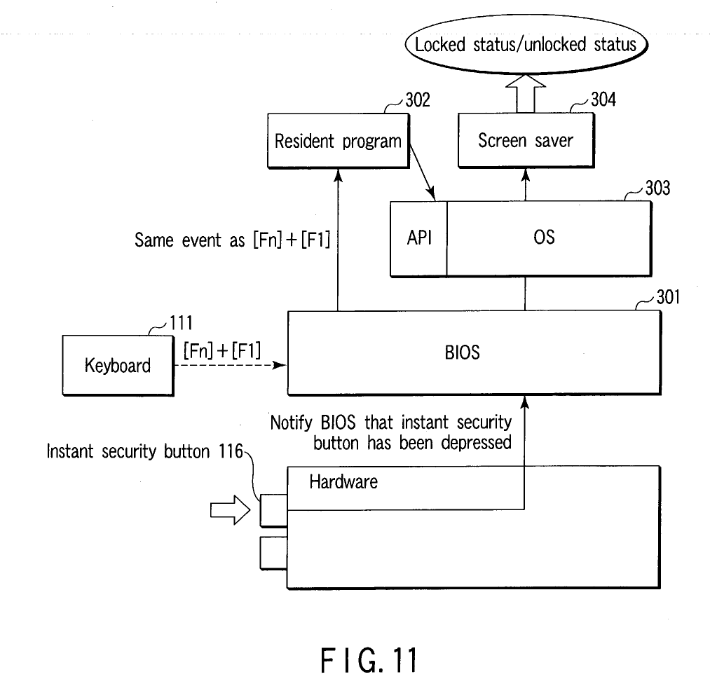

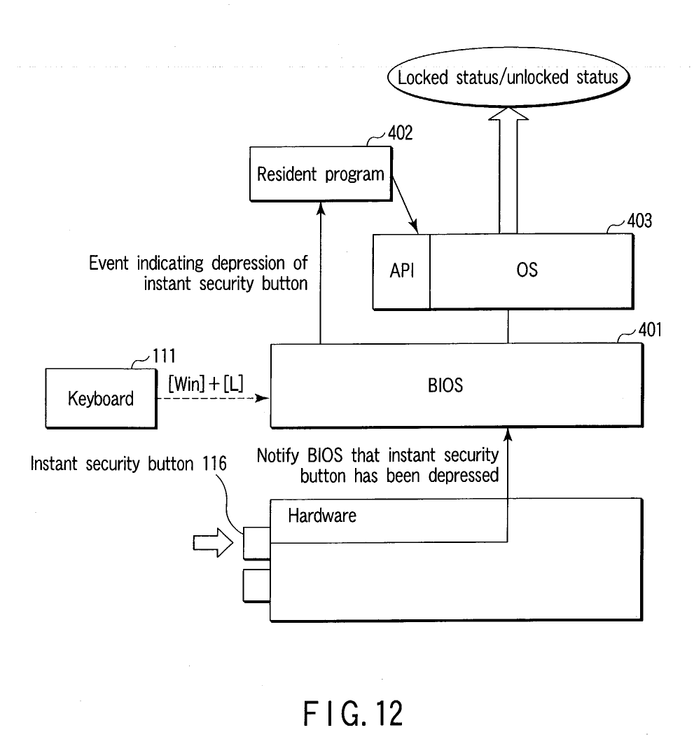

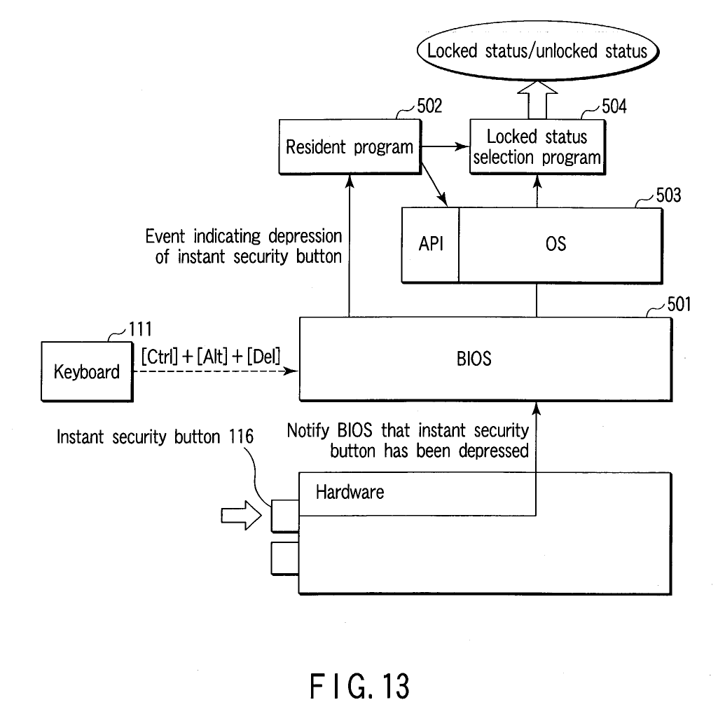

In the above described first to third examples, an instruction to lock the system is given by depressing the instant security button 22 on the remote control unit 21 as is apparent from FIGS. 4, 7, and 9. On the other hand, an instruction to lock the system may be given by depressing the accessory button (instant security button) 116 on the computer main body 11 rather than using the remote control unit 21. A configuration example is shown in FIGS. 11, 12, and 13. FIGS. 11, 12, and 13 correspond to FIGS. 4, 7, and 9.

Except for the mechanism that notifies the BIOS of depression of the button, the same arrangements and operations are used for the case in which the instant security button 116 on the computer main body 11 is used and for the case in which the instant security button 22 on the remote controller 21 is used.

As described above, according to the present embodiment, it is possible to cause the system to be easily locked by depressing the instant security button 22 on the remote control unit or the instant security button 116 on the computer main body.

Further, according to the present embodiment, the system can be easily locked by allowing the BIOS 301 to emulate an operation of depressing the “Fn”+“F1”, a combination of keys used to activate the system locking screen saver.

Furthermore, according to the present embodiment, the system can be easily locked by allowing the resident program 402 to emulate an operation of depressing the “Win”+“L”.

Moreover, according to the present embodiment, the system can be easily locked by allowing the resident program 502 to emulate an operation of depressing the “Ctrl”+“Alt”+“Del”.

As described above in detail, according to the present invention, it is possible to cause the system to be easily locked by a single button operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a button to be depressed; and
a control section which emulates a key depressing operation corresponding to a system locking operation when the button is depressed.

2. The information processing apparatus according to claim 1, wherein the control section includes a basic input/output system which is capable of emulating the key depressing operation.

3. The information processing apparatus according to claim 2, wherein when the button is depressed, the basic input/output system issues a same event as that issued when the key depressing operation is performed.

4. The information processing apparatus according to claim 3, further comprising an activating section which activates a screen saver which locks the system, in response to the event issued by the basic input/output system.

5. The information processing apparatus according to claim 1, further comprising a basic input/output system which is capable of issuing an event indicating that the button has been depressed, wherein
the control section has a program which emulates the key depressing operation in response to the event issued by the basic input/output system.

6. The information processing apparatus according to claim 5, wherein the program activates a program which locks the system in response to the event issued by the basic input/output system.

7. The information processing apparatus according to claim 1, wherein the button is provided on a remote control unit.

8. The information processing apparatus according to claim 1, wherein the button is provided on a body of the information processing apparatus.

9. An information processing apparatus comprising:
a button to be depressed;
a basic input/output system which issues an event when the button is depressed, the event being a same event as that issued when a key depressing operation is performed to activate a screen saver which locks the system; and
an activating section which activates the screen saver which locks the system, in response to the event issued by the basic input/output system.

10. The information processing apparatus according to claim 9, wherein the button is provided on a remote control unit.

11. The information processing apparatus according to claim 9, wherein the button is provided on a body of the information processing apparatus.

12. A system locking method applied to an information processing apparatus, comprising:
detecting an operation of depressing a specific button; and
emulating a key depressing operation corresponding to a system locking operation when the button is depressed.

13. The method according to claim 12, wherein the emulation is executed using a basic input/output system.

14. The method according to claim 13, further comprising, when the button is depressed, issuing from the basic input/output system an event being a same event as that issued when the key depressing operation is performed.

15. The method according to claim 14, further comprising activating a screen saver which locks the system, in response to the event issued from the basic input/output system.

16. The method according to claim 12, further comprising:
issuing from a basic input/output system an event indicating that the button has been depressed; and
emulating the key depressing operation in response to the event issued from the basic input/output system.

17. The method according to claim 16, further comprising activating a program which locks the system, in response to the event issued from the basic input/output system.

18. The method according to claim 12, wherein the button is provided on a remote control unit.

19. The method according to claim 12, wherein the button is provided on a body of the information processing apparatus.

20. A system locking method applied to an information processing apparatus, comprising:
detecting an operation of depressing a specific button;
issuing an event from a basic input/output system when the button is depressed, the event being a same event as that issued when a key depressing operation is performed to activate a screen saver which locks the system; and
activating the screen saver which locks the system, in response to the event issued from the basic input/output system.

21. The method according to claim 20, wherein the button is provided on a remote control unit.

22. The method according to claim 20, wherein the button is provided on a body of the information processing apparatus.
